(19) United States
(12) Patent Application Publication
(10) Pub. No.: US 2012/0174039 A1
(43) Pub. Date: Jul. 5, 2012

(54) SYSTEMS AND METHODS FOR NAVIGATING THROUGH CONTENT IN AN INTERACTIVE MEDIA GUIDANCE APPLICATION

(75) Inventors: Jeffrey Lester Rhoads, Downingtown, PA (US); Hans Andreas Baumgartner, San Diego, CA (US)

(73) Assignee: UNITED VIDEO PROPERTIES, INC., Santa Clara, CA (US)

(21) Appl. No.: 13/339,233

(22) Filed: Dec. 28, 2011

Related U.S. Application Data
(60) Provisional application No. 61/430,157, filed on Jan. 5, 2011.

(51) Int. Cl. G06F 3/048

(52) U.S. Cl. 715/854

(57) ABSTRACT

Systems and methods for navigating through content in an interactive media guidance application are provided. Media assets are displayed in response to a user selecting a media identifier from a list of media identifiers. In response to receiving a user selection of a media asset, a navigation indicator associated with the media asset is stored, where the navigation indicator represents a path for navigating through the hierarchy of the interactive media guidance application to the media asset. In response to determining that the media asset is being played back after the user navigates away from the media identifier to another media identifier, the navigation indicator is displayed within the interactive media guidance application.

### CROSS-REFERENCE TO RELATED APPLICATION

This application claims the benefit under 35 U.S.C. §119 (e) of U.S. Provisional Patent Application No. 61/430,157, filed Jan. 5, 2011, which is hereby incorporated by reference herein in its entirety.

### BACKGROUND OF THE INVENTION

Due to the overwhelming volume of content available to the average person, it can be difficult to manage content for playback on a particular consumer electronics (CE) device. This is especially the case when there are multiple playback devices, multiple playback device types, multiple content sources, and multiple instances (copies) of a particular desired item of content.

Many of these consumer electronics devices provide a web browsing application for navigating through hyperlinks provided on webpages to retrieve content. Although web surfing and hyperlinks may provide a convenient way to obtain Internet content, web surfing is not well suited for selecting among an array of content items for viewing or listening to content on such a device. Moreover, this may become increasingly difficult as content is obtained from multiple content sources.

### SUMMARY OF THE INVENTION

In view of the foregoing, systems and methods for navigating through content in an interactive media guidance application are provided. In particular, the interactive media guidance application may display a navigation indicator within the interactive media guidance application in response to determining that a media asset is being played back and that the user has navigated away from the media asset. The navigation indicator may allow a user to navigate back through a hierarchical structure of media identifiers to the location of the media asset.

In some embodiments, a guidance display containing media assets and media identifiers is provided. Media identifiers may be arranged in a hierarchy of the interactive media guidance application. For example, the control circuitry may generate a hierarchical tree structure having nodes that each correspond to a media identifier. In a more particular example, the control circuitry may transmit a query to a media content source, a media guidance data source, a metadata source, or any other suitable source to retrieve navigation hierarchy information to generate one or more guidance displays. Media assets stored in one or more sources may then be retrieved by transmitting one or more queries corresponding to the nodes of the hierarchical tree structure.

In response to receiving a user selection of a media identifier from multiple media identifiers, the control circuitry may retrieve media assets for presentation to the user. For example, in response to receiving a user selection of the “U.S.” media identifier (a child node of “Associated Press” media identifier) from a list of identifiers, the control circuitry may cause multiple media assets associated with the “U.S.” media identifier to be displayed to the user. It should be noted that the media identifier is in a first position within the hierarchy.

In response to receiving a user selection of a media asset from multiple media assets, the control circuitry stores a navigation indicator associated with the media asset, where the navigation indicator represents a path for navigating through the hierarchy of the interactive media guidance application to the media asset.

The control circuitry may determine that the media asset is being played back to the user (e.g., in a video window, from a media queue or playlist, etc.). The control circuitry may also determine whether the user has moved a highlight region or cursor away from the first position within the hierarchy corresponding to the selected media identifier. In response to determining that the user has navigated away from the selected media identifier to another media identifier, where this media identifier is in a second position within the hierarchy, the control circuitry may cause the navigation indicator to be displayed within the interactive media guidance application.

In some embodiments, the control circuitry may display a navigation indicator that includes one or more navigation cues. For example, the first navigation indicator may include a first navigation cue that identifies which media identifier to select from a first portion of the media identifiers and a second navigation cue that identifies which media identifier to select from a second portion of media identifiers after selecting the media identifier from the first portion in order to navigate back to the first media asset. The first and second navigation cues may be placed adjacent to the particular media identifier. The first and second navigation cues may also be any suitable shape, color, size, ordering of shapes (e.g., the first navigation cue is circular and the second navigation cue is rectangular), and/or ordering of colors (e.g., the first navigation cue is blue and the second navigation cue is yellow).

In some embodiments, the control circuitry may display a header region in the guidance display that includes a directory of the user-navigated locations within the hierarchy of the interactive media guidance application. For example, the control circuitry may transmit a query that requests the media identifiers selected to obtain a list of media assets that includes the selected media asset. Upon receiving the response to the query, the control circuitry may compile the retrieved media identifier information into a directory within a header region in the guidance display.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative displays screen that may be used to provide media guidance application listings in accordance with some embodiments of the invention;

FIG. 3 shows an illustrative user equipment device in accordance with some embodiments of the invention;

FIG. 4 is a diagram of an illustrative cross-platform interactive media system in accordance with some embodiments of the invention;

FIG. 5 shows an illustrative display screen that may be used to provide lists of media identifiers and a queue of media assets, where navigation indicators are placed adjacent to selected media identifiers, in accordance with some embodiments of the invention;

FIG. 6 shows an illustrative display screen that may be used to provide lists of media identifiers and a queue of media assets, where navigation indicators may not be displayed, in accordance with some embodiments of the invention;

FIG. 7 shows an illustrative display screen that may be used to provide lists of media identifiers and a queue of media assets, where navigation indicators are provided in response to media playback and user navigation, in accordance with some embodiments of the invention;

FIG. 8 shows an illustrative display screen that may be used to provide navigation indicators that include directional navigation cues in accordance with some embodiments of the invention;

FIGS. 9A-9F shows an illustrative display screen that may be used to provide multiple navigation indicators in accordance with some embodiments of the invention;

FIG. 10 shows an illustrative display of a full screen video region with media asset information in accordance with some embodiments of the invention;

FIG. 11 illustrates a flow diagram for providing a navigation indicator and/or navigation cues in a guidance in accordance with some embodiments of the invention; and

FIG. 12 shows an illustrative example of a file in Extensible Markup Language (XML) for storing and retrieving media identifiers, media assets, and/or navigation indicators used to generate guidance displays in accordance with some embodiments of the invention.

### DETAILED DESCRIPTION OF EMBODIMENTS

This invention generally relates to systems and methods for navigating through content in an interactive media guidance application. In particular, systems and methods are provided for displaying a navigation indicator within the interactive media guidance application in response to determining chat a media asset associated with the navigation indicator is being played back and that the user has navigated away from a media identifier associated with the media asset. The navigation indicator may allow a user to navigate back through a hierarchical structure of media identifiers to the location of the media asset.

The amount of content available to users in any given content delivery system can be substantial. Consequently, many users desire a form of media guidance through an interface that allows users to navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same, Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

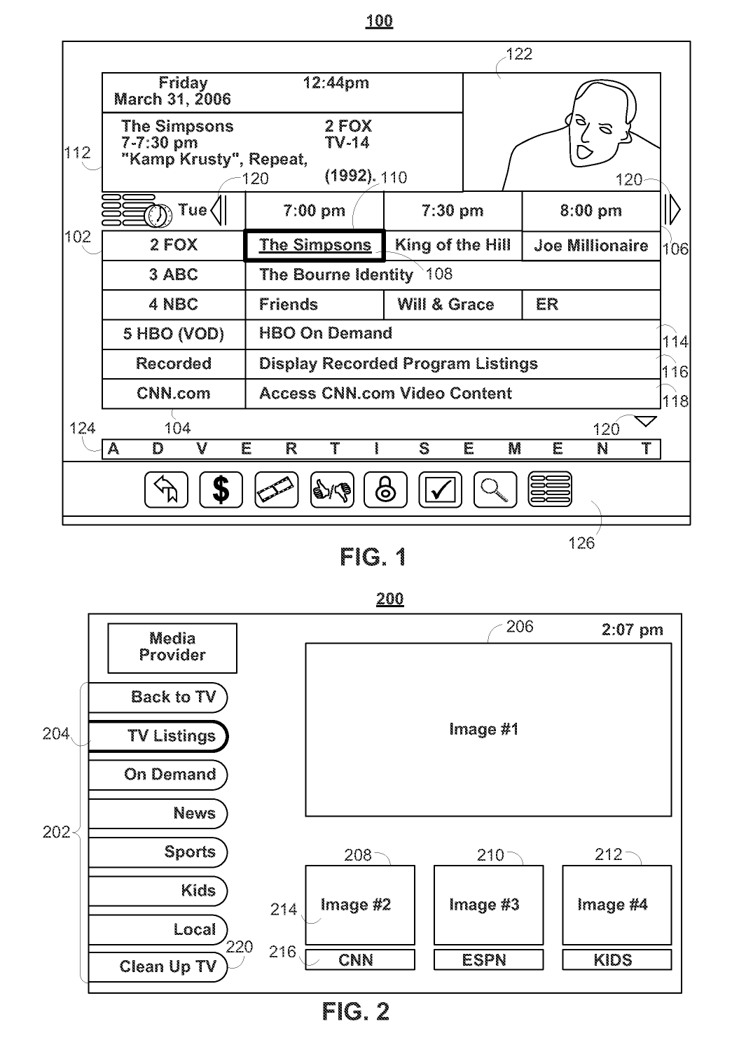

FIGS. 1-2 show illustrative display screens that may be used to provide media guidance data. The display screens shown in FIGS. 1-2 and 5-10 may be implemented on any suitable user equipment device or platform. While the displays of FIGS. 1-2 and 5-10 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted no a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated no on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,373, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al, U.S. Patent Application Publication No. 2003/0110499, filed. Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe no a premium service, options to edit a user's profile, options to access a browse overlay, or other options.

In some embodiments, the user may navigate through lists of media identifiers. The media identifiers may be arranged in a hierarchy of the interactive media guidance application. The user may request that the interactive media guidance application navigate through the hierarchy of media identifiers by positioning highlight region 110 over a media identifier and pressing a suitable key on a user input device (e.g., a mouse button, an arrow key, etc.). Alternatively, when the media guidance application is executed on a wireless communications device with a touch screen, the user may make contact with the touch screen using any suitable object or appendage, such as a stylus, finger, etc. For example, instead of pressing a suitable button on a user input device, the media guidance application may respond to contact with a touch screen, such as one or more taps on the touch screen, maintaining continuous contact with the touch screen, movement of the point of contact while maintaining continuous contact, a breaking of the contact, or any combination thereof. Upon selecting one or more media identifiers, the interactive media guidance application may provide the user with a list of one or more media assets for selection.

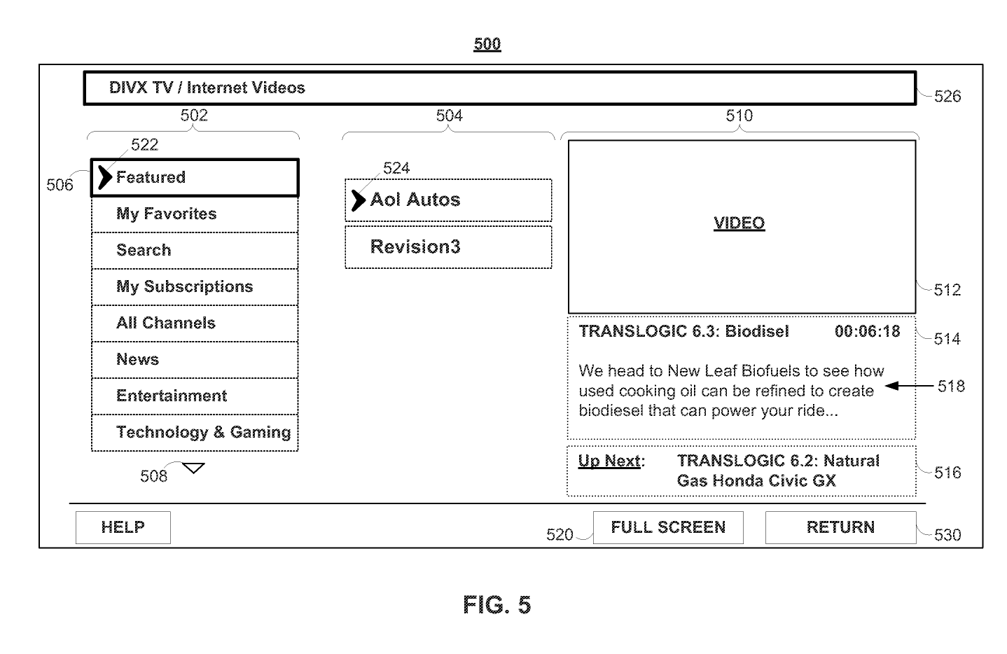

In some embodiments, in response to receiving a user selection of a media asset from the list of media assets, the media guidance application may store a navigation indicator associated with the selected media asset. The navigation indicator may represent, for example, a path for navigating through the hierarchy of the interactive media guidance application to the selected media asset. For example, as shown in FIGS. 5-10, the media guidance application may determine when the user has selected a media asset (e.g., a video clip entitled “Lab Seeks Clues After 3,000 Birds Die in Arkansas”) and, in response, may generate a navigation indicator for presentation when the user navigates away from the media identifier that provided the list of media assets containing the selected media asset.

In some embodiments, the media guidance application may monitor the navigation of the user and/or the playback of media assets. In response to determining that the selected media asset is being played back (e.g., in a video window), the media guidance application may also determine whether the user has navigated away from the media identifier associated with the selected media asset. For example, the media guidance application may compare the current location of a highlight region or cursor with the location of the selected media identifier that provided the list of media assets containing the selected media asset. In another example, the media guidance application may determine that the selected media asset is being played back after the user navigates away from the media identifier associated with the media asset to another media identifier. It should be noted that the second media identifier is in a second position within the navigation hierarchy. In response, the interactive media guidance application may display the navigation indicator.

As shown in FIGS. 5-10, the media guidance application may display a navigation indicator that includes one or more navigation cues. The navigation indicator may use navigation cues to provide the user with a visual indication for navigating back to the location of the selected media asset.

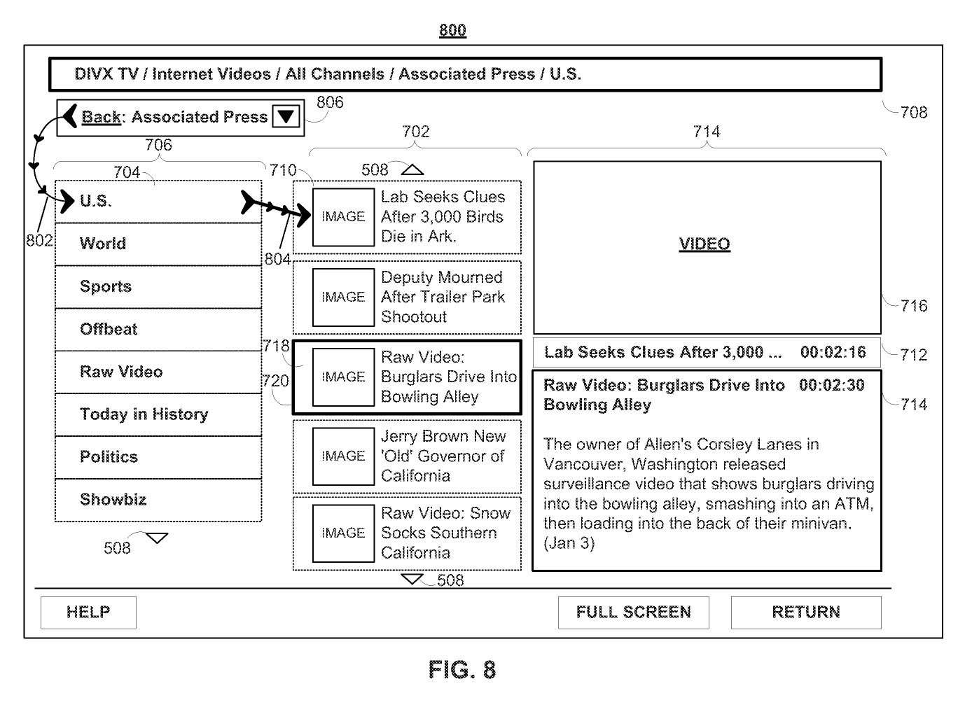

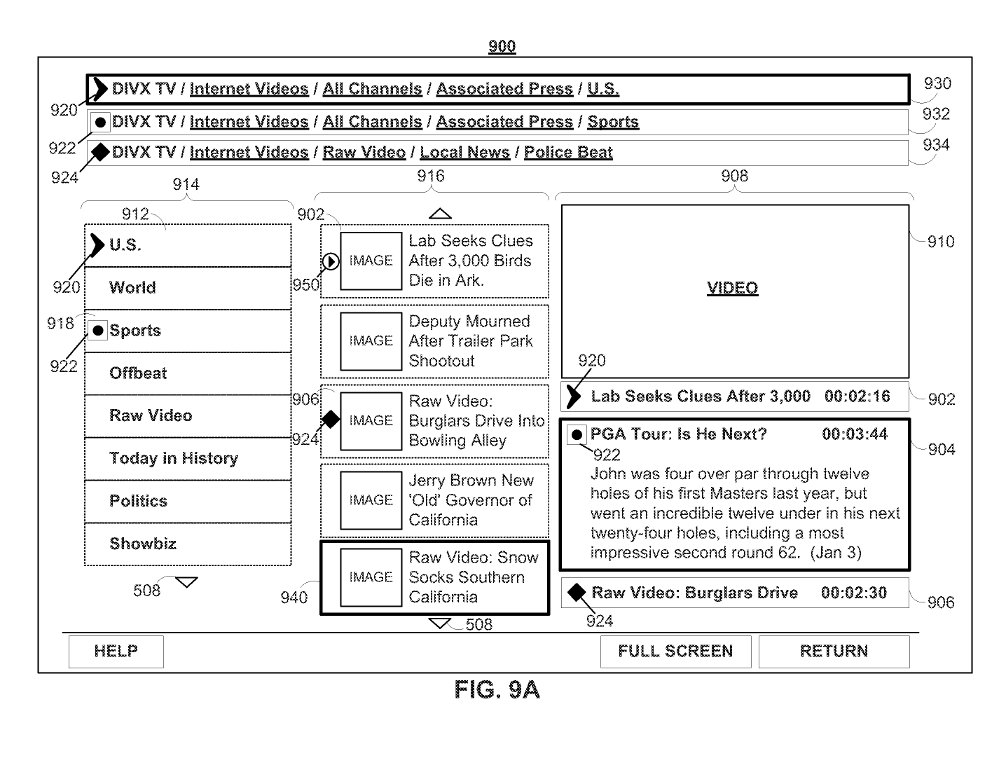

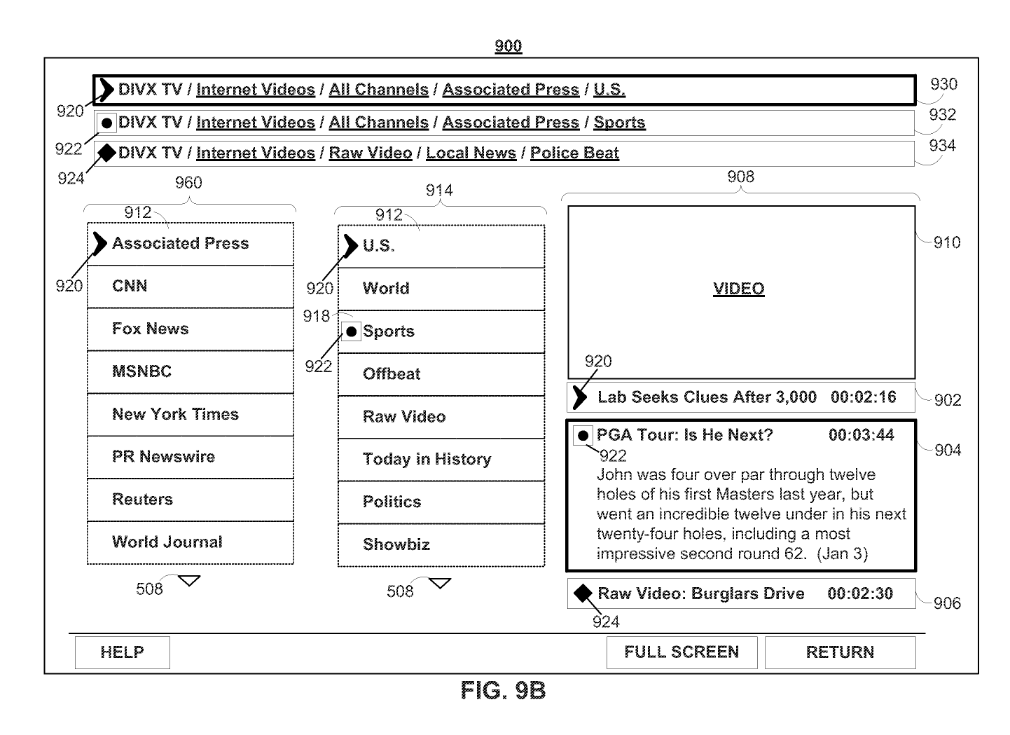

In some embodiments, the media guidance application may place navigation cues adjacent to the particular media identifier. For example, the navigation indicator may include a first navigation cue that identifies which media identifier to select from a first portion of media identifiers (e.g., the “U.S.” media identifier in FIG. 8) and a second navigation cue that identifies which media identifier to select from a second portion of media identifiers (e.g., the “Associated Press” media identifier in FIG. 8) to navigate back to the media asset being played back. In some embodiments, the media guidance application may provide navigation cues at different times or in different portions of the guidance display. For example, the media guidance application may display the second navigation cue after selecting the media identifier from the first portion in order to guide the user back to the first media asset.

In some embodiments, the media guidance application may provide navigation cues with a directional component (e.g., an arrow that directs the user) to indicate the path for navigating through the hierarchy of media identifiers. It should also be noted that the interactive media guidance application may render the navigation cues using any suitable color, shape, order of colors, order of shapes, etc.

In some embodiments, the media guidance application may display a header region that includes a directory of the user-navigated locations within the hierarchy of the interactive media guidance application. The header region may provide the user with the opportunity to view each media identifier selected from different portions of media identifier lists for navigating to the selected media asset. The interactive media guidance application may configure each media identifier in the header region to be selectable such that the user may return to a particular listing of media identifiers.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

For example, as described above, the interactive media guidance application may display one or more navigation indicators that each includes navigation cues. The media guidance application may display navigation cues based on a user profile (e.g., particular color scheme), user history, etc. For example, the interactive media guidance application may provide the user with an opportunity to set navigation indicator options within a user profile in another example, the media guidance application may display some navigation cues but not others navigation cues based on user history and/or user preferences.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,093, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

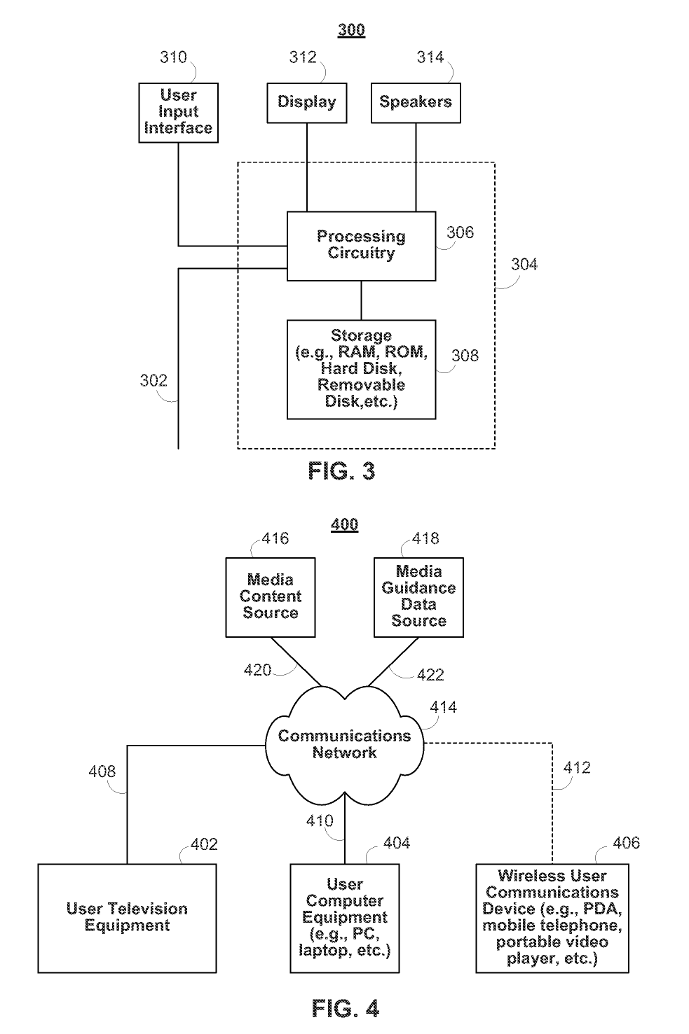

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network. (WAN), and/or other content) and data to control circuitry 304, which includes processing circuitry 306 and storage 308. Control circuitry 304 may be used so send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood so mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (PD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver not shown), which processes and outputs the audio via speakers 314.

In some embodiments, control circuitry 304 may be configured to receive instructions from user input interface 310. For example, control circuitry 304 may cause a guidance display that contains media assets and media identifier to be presented by selecting a selectable option in a display screen (e.g., a listings option, an “Internet Videos” option, a “DivXTV” option, etc.).

In some embodiments, control circuitry 304 may be configured to receive an instruction from user input interface 310 to select a media identifier from a list of media identifiers. In response to receiving the instruction, control circuitry 304 may transmit a query with the selected media identifier to retrieve additional media listings and/or media assets for presentation to the user.

Alternatively, in response to receiving a request to access the guidance display (e.g., selecting a “DivXTV” option), control circuitry 304 may transmit a query to media content source 416, media guidance data source 418, or any other suitable source to retrieve navigation hierarchy information to generate the guidance display. In some embodiments, control circuitry 304 may use the navigation hierarchy information to generate one or more guidance displays that contain media identifiers and media assets for the particular user equipment executing the interactive media guidance application.

In response to navigating through the hierarchy in the interactive media guidance application, control circuitry 304 may display multiple media assets for selection by the user. In response to receiving a user selection of a media asset from the displayed media assets, control circuitry 304 may store a navigation indicator associated with the media asset. As described above, the navigation indicator may represent a path for navigating through the hierarchy of the interactive media guidance application to the selected media asset.

In some embodiments, control circuitry 304 may monitor the navigation of the user within the interactive media guidance application and/or the playback of media assets. In response to determining that the media asset associated with the navigation indicator is being played back (e.g., in a video window), control circuitry 304 may also determine whether the user has moved a highlight region or cursor away from the position within the hierarchy corresponding to the selected media identifier. In response to determining that the media asset is being played back and that the user has navigated away from the media identifier associated with the selected media asset, control circuitry 304 may cause the navigation indicator to be displayed to the user.

In some embodiments, control circuitry 304 may display a navigation indicator that includes one or more navigation cues. The navigation indicator uses one or more navigation cues to provide the user with a visual indication for navigating back to the location of the selected media asset. For example, the navigation indicator may include a first navigation cue that identifies which media identifier to select from a first portion of the media identifiers and a second navigation cue that identifies which media identifier to select from a second portion of media identifiers. Control circuitry 304 may display the second navigation cue, for example, after selecting the media identifier from the first portion in order to navigate back to the first media asset.

In some embodiments, control circuitry 304 may place navigation cues adjacent to the particular media identifiers. For example, the navigation indicator may include a first navigation cue that identifies which media identifier to select from a first portion of media identifiers (e.g., a media identifier from a first listing of media identifiers) and a second navigation cue that identifies which media identifier to select from a second portion of media identifiers (e.g., a media identifier from a first listing of media identifiers) to navigate back to the media asset being played back.

In some embodiments, control circuitry 304 may render the navigation cues using different colors, different shapes, etc. For example, a first navigation cue that identifies a media identifier from a first listing of media identifiers may be a yellow icon, while a second navigation cue that identifies a media identifier from a second listing of media identifiers may be a blue icon.

In some embodiments, control circuitry 304 may provide the user with additional guidance for navigating through media identifiers and, in some cases, navigating such that the user may return back to the location within the navigation hierarchy where the media asset is currently being played back. For example, in some embodiments, control circuitry 304 may display a header region that includes a directory of the user-navigated locations within the hierarchy of the interactive media guidance application. The header region may provide the user with the opportunity to view each media identifier selected from different portions of media identifier lists for navigating no the selected media asset.

Accordingly, control circuitry 304 may provide navigation indicators and/or navigation cues to assist the user navigate back to a selected media asset. These navigation indicators and/or navigation cues may be used in a variety of application. For example, the user may have a desire to view or listen to a media asset from the same content source that is currently providing the media asset. In another example, the user may have a desire to view or listen to related media assets associated with the media identifier of the media asset that is currently being played back. In yet another example, the user may have a desire to traverse the same path that led the user to the media asset. In a more particular example, the user may have recalled another media asset that interested the user, but was not selected by the user as the user traversed that path.

The guidance application may be implemented using any suitable architecture. For example, it may be a stand-alone application wholly implemented on user equipment device 300 in such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can chance the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USE cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on demand content provider, an Internet provider of content of broadcast programs for downloading, etc.) Content source 416 may include cable sources, satellite providers, on-demand providers, Internet providers, over-the-top content providers, or other providers of content, Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided no the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be for example, stand-alone applications implemented on user equipment devices. For example, the media guidance application may be implemented as software or a set of executable instructions which may be stored in storage 308, and executed by control circuitry 304 of a user equipment device 300 in some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content, OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer an their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al, U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 may present a guidance display for selecting and playing back media assets, such as Internet content. For example, as shown in FIGS. 5-10, the guidance displays provided by control circuitry 304 include a media queue or playlist for adding multiple media assets and playing back media assets in a video window. Using the media queue, control circuitry 304 may allow the user to watch, listen to, or otherwise consume multiple media assets in succession, navigate between different media assets in the media queue (e.g., switch from watching one media asset to another media asset), and re-order media assets for playback in a video window.

FIG. 5 shows an illustrative guidance display 500 that includes a plurality of media identifiers or selecting media assets for playback in accordance with some embodiments of the invention. Similar to FIG. 1, a user may indicate a desire to access media guidance information by selecting a selectable option provided in a display screen (e.g., an “Internet Videos” option, a “DivXTV” option) or pressing a dedicated button (e.g., a GUIDE button) on a user input interface or device. In response to receiving a request to access guidance display 500, control circuitry 304 may transmit a query to media content source 416, media guidance data source 413, or any other suitable source to retrieve navigation hierarchy information. Control circuitry 304 may use the retrieved, navigation hierarchy information to generate display 500 with arranged lists of media identifiers that the user may to navigate through using, for example, a user input device.

As shown in FIG. 5, guidance display 500 may include lists as media identifiers, such as a first list of media identifiers 502 and a second list of media identifiers 504. More particularly, in response to selecting one of the media identifiers in first list of media identifiers 502, control circuitry 304 may present the user with second list of media identifiers 504. For example, in response to receiving a user selection of a media identifier from first list of media identifiers 502, such as the “Featured” media identifier, using a highlight region 506, control circuitry 304 may present the user with second list of media identifiers 504. Second list of media identifiers 504 may include media identifiers, such as the “Aol Autos” media identifier and the “Revision3” media identifier.

Control circuitry 304 may provide additional media guidance data, such as additional media identifiers, in response to the user selecting one of the navigational icons 508. Pressing an arrow key on a user input, device providing an appropriate gesture on a touch screen interface may affect the display in a similar manner as selecting navigational icons 508. In addition, control circuitry 304 may provide navigational icons 508 to indicate the availability of additional media identifiers and/or additional media assets for selection.

It should be noted that each list of media identifiers may correspond to a level of the navigation hierarchy. For example, control circuitry 304 may provide highlight region 506 to indicate the current navigation location of the user. In response to moving highlight region 506 to the left or right, thereby revealing a column or list of media identifiers to the left of first list of media identifiers 502 or the right of second list of media identifiers 504, control circuitry 304 reveals another level of the navigation hierarchy. As the user continues to navigate through the hierarchy, control circuitry 304 provides the user with lists of media identifiers until providing a terminal node or branch that is generally a list of media assets for user selection. For example, with regard to the navigation hierarchy, second list of media identifiers 504 may be a child node to a media identifier in first list of media identifiers 502. Following this example, additional lists of media identifiers may be displayed with each selection until control circuitry 304 displays a list of media assets.

As also shown in FIG. 5, display 500 includes a media queue region 510. Control circuitry 304 may configure media queue region 510 to allow the user to select, and queue multiple media assets for playback. Media queue region 510 may include, for example, a video region 512 and media asset listings 514 and 516 corresponding to the media assets selected by the user and placed in the media queue. Video region 512 may allow the user to view and/or preview media assets that are currently available, will be available, or were available to the user. The content of video region 514 may correspond to, or be independent from, one of the media assets displayed in guidance display 500.

For example, in the example of FIG. 5, control circuitry 304 has received an indication that the user has selected a media asset 514 entitled “TRANSLOGIC 6.3: Biodiesel.” In response to selecting media asset 514 from a list of media assets, control circuitry 304 may place media asset 514 into the media queue displayed in media queue region 510. In addition, control circuitry 304 may store into memory a navigation indicator associated with media asset 514. The navigation indicator may represent a path for navigating through the navigation hierarchy of the interactive media guidance application to media asset 514. For example, control circuitry 304 may store into a memory an identifier corresponding to the selected media asset and the one or more media identifiers selected by the user to access media asset 514 (e.g., “Internet Videos,” “Featured,” “AOL Autos,” and “Translogic”). In another example, control circuitry 304 may store in memory the media identifier that provided the list of media assets containing the selected media asset.

In some embodiments, control circuitry 304 may allow the user to select additional media assets for playback. For example, as shown in media queue region 510 of FIG. 5, control circuitry 304 has received an indication that the user has selected an additional media asset 516 entitled “TRANSLOGIC 6.2: Natural Gas Honda Civic GX.” In response to selecting media asset 516 from a list, of media assets, control circuitry 304 may place media asset 516 into the media queue displayed in media queue region 510. As media queue already includes media asset 514, media asset 516 is placed in the media queue for playback after media asset 514 has been played back. Control circuitry 304 may also indicate that media asset 516 is the upcoming media asset for playback. In addition, control circuitry 304 may store into memory a navigation indicator associated with media asset 516.

Alternatively, control circuitry 304 may automatically select media assets for playback to the user. For example, in response to determining that the user has selected media asset 514 for playback and no other media assets, control circuitry 304 may automatically select the following media asset in a sequence or listing of media assets—e.g., play the “TRANSLOGIC 6.2” media asset after playing the “TRANSLOGIC 6.3” media asset. In another example, based on the user history information, user profile information, and/or past consumption of media assets, control circuitry 304 may select recommended media assets and place the recommended media assets in the media queue for playback to the user. In vet another example, upon accessing guidance display 500 of the interactive media guidance application, control circuitry 304 may automatically begin playing back media asset (e.g., featured media assets in a particular listing like media asset 514 entitled “TRANSLOGIC 6.3: Biodiesel,” media assets previously placed in the media queue by the user, media assets previously placed in the media queue but not consumed by the user, etc.).

In addition to placing media in the media queue for playback, control circuitry 304 may provide the user with access to information corresponding to the Queued media assets. For example, as shown in FIG. 5, control circuitry 304 may receive an indication that the user has placed highlight region 506 over media asset 514 in media queue region 510. In response to selecting media asset 514 while in media queue region 510, control circuitry 304 may cause the listing for media asset 514 to expand to include information portion 518. Information portion 518 may provide the user with access to information corresponding to media asset 514, such as a description of the content being display, a written article that corresponds to the media asset, etc. Alternatively, control circuitry 304 may provide information portion 518 in an overlay or pop-up window. Control circuitry 304 may cause the overlay to be removed from guidance display 500, for example, after a predetermined amount of time (e.g., 30 seconds).

In some embodiments, control circuitry 304 may allow the use to re-order media assets placed in the media queue in media queue region 510. For example, in response to selecting media asset 514 using highlight region 506, control circuitry 304 may allow the user to move media asset 514 to a location below media asset 516. In this example, media asset 514 moves up to the top of the media queue and begins playback in video region 512.

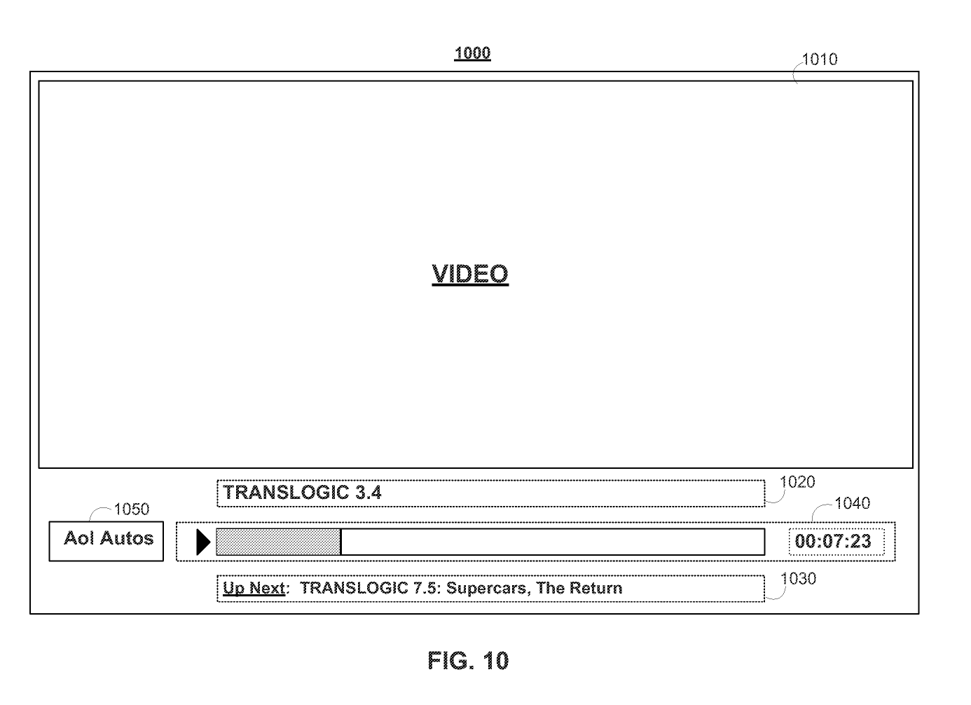

In some embodiments, control circuitry 304 may provide a full screen option 520 for playing a media asset in a full sized display screen. An example of a full sized display screen playing back a media asset is described later in connection with FIG. 10. Alternatively, control circuitry 304 may play back the media asset in a full sized display screen in response to the user placing highlight region 506 over video region 512 and pressing a select button, selecting video region 512 with a user input device, etc.

It should also be noted that, while media asset 514 or any other media asset is played back in video region 510, the media queue region 510 (including video region 512, media asset 514, and media asset 516) may be persistent as the user navigates through the media identifiers and/or media assets of the interactive media guidance application. For example, as the user navigates through first list of media identifiers 502, second list of media identifiers 504, other lists of media identifiers, and/or other lists of media assets, control circuitry 304 may continue to display media queue region 510 and may continue so playback media assets, such as media assets 514 and 518, within video region 512.

In some embodiments, control circuitry 304 may monitor the navigation of the user within the interactive media guidance application and may monitor the playback of media assets in media queue region 510.

For example, control circuitry 304 may determine if a media asset is currently being played back in video region 512 of media queue region 510. If the media asset, such as media asset 514, is currently being played back, control circuitry 304 may retrieve the navigation indicator associated with media asset 514 and determine whether the user has navigated away from the media identifier associated with the selected media asset. For example, control circuitry 304 may retrieve, from the navigation indicator, location information of the media identifier that causes the display of the list of media assets that includes media asset 514. Control circuitry 304 may also retrieve the current location of highlight region 506 and compare it with the location information from the navigation indicator. In another example, control circuitry 304 may retrieve, from the navigation indicator, the location of the media asset and may compare the current location of highlight region 506 with the location of the media asset.

In response to determining that the user has navigated away from the media identifier and, for example, to another media identifier or another portion of guidance display 500, control circuitry 304 may cause the navigation indicator associated with the media asset being played back to be displayed to the user.

In some embodiments, control circuitry 304 may provide the navigation indicator with one or more navigation cues. The navigation indicator with one or more navigation cues may provide the user with a visual indication for navigating back to the location of the associated media asset. For example, as shown in FIG. 5, navigation indicator includes at least a first navigation cue 522 and a second navigation cue 524 placed adjacent to particular media identifiers. First navigation cue 522 identifies which media identifier to select, from a first portion of media identifiers (e.g., the “Featured” media identifier from first listing of media identifiers 502) and second navigation cue 524 that identifies which media identifier to select from a second portion of media identifiers (e.g., the “Aol Autos” media identifier from second listing of media identifiers 504). This allows she user to navigate bank to media asset 514 that is currently being played back in video region 512.

In some embodiments, navigation cues 522 and 524 of the navigation indicator may include a directional component. For example, control circuitry 304 may display navigation cues 522 and 524 as directional arrows, which point the user in the direction through the navigation hierarchy to navigate back to the listing of media assets that includes media asset 514 that is currently being played back in video region 512. In a more particular example, control circuitry 304 may display navigation cues 522 and 524 to direct the user towards the right to obtain additional lists of media identifiers or the list of media assess. In another example, control circuitry 304 may provide navigation cues 522 and 524 as selectable options and, in response to selecting navigation cue 522 or 524, control circuitry 304 may direct highlight region 506 or any other suitable cursor to the next media identifier within the navigation hierarchy (e.g., the following media identifier “TRANSLOGIC” in the hierarchy). In yet another example, navigation cues 522 and 521 may be displayed in a particular order, where navigation cue 522 is displayed and, upon selecting the media identifier indicated by navigation cue 524, navigation cue 524 is then displayed.

In some embodiments, navigation cues 522 and 524 of the navigation indicator may be any suitable shape (e.g., arrows, circular, rectangular, etc.), any suitable color (e.g., blue, yellow, etc.), any suitable order of shapes (e.g., arrows for the first and second lists of media identifiers 502 and 504 and rectangles for the media identifier that leads to the list of media assets, any suitable order of colors, etc. For example, navigation cues 522 and 524 may be assigned a color within a range of colors based on the distance or a distance metric from the associated media asset. In a more particular example, navigation cues 522 and 524 along with other navigation cues may be assigned a bright shade of red when the navigation cue is close to the location of the associated media asset or assigned a light shade of yellow when the navigation cue is far from the location.

In some embodiments, control circuitry 304 may display a header region 526 that includes a directory of the user-navigated locations within the hierarchy of the interactive media guidance application. For example, control circuitry 304 may retrieve, from memory, the media identifiers associated with media asset 514 that is currently being played back in video region 512 and generate a directory including all of the selected media identifiers to navigate through the navigation hierarchy. In some embodiments, control circuitry 304 may allow the user to select header region 526 to direct display 500 and highlight region 506 to the list of media assets that includes media asset 514.

Alternatively, display 500 may include a return option 530. In response to receiving an indication that the user has selected return option 530, control circuitry 304 may alter first list of media identifiers 502 and/or second list of media identifiers 504 such that the user is returned to the location within the interactive media guidance application that includes the list of media assets including the media asset being played back. In some embodiments, control circuitry 304 may provide an animation or a sequence of images that shuffles through In the lists of media identifiers before arriving at the list of media assets including the media asset being played back.

It should be noted that, although the embodiments described herein generally refer to retrieving and playing back video content, such as Internet video content, this is merely illustrative. Any suitable content may be consumed using the interactive media guidance application, such as audio content, images, television programs, text, etc.

In some embodiments, control circuitry 304 may determine that a media asset is being played back and that user has navigated away from the media asset and, in response, may not present the user with a navigation indicator.

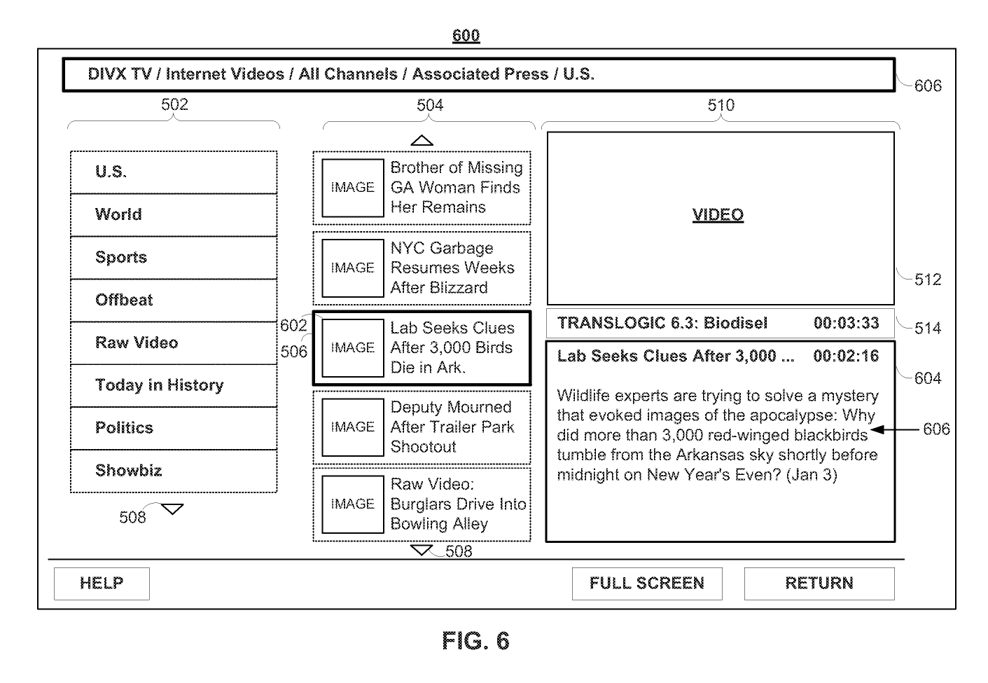

For example, as shown in FIG. 6, the user has navigated to a different section of the interactive media guidance application. In particular, the user has navigated to and selected a media asset 602 entitled “Lab Seeks Clues After 3,000 Birds Die in Arkansas” for playback. In response, control circuitry 304 adds media asset 602 into the media queue in media queue portion 510 (as shown by media listing 604) for playback after media asset 514, which is currently being played back. An information portion 604 that provides a description of media asset 602 may also be displayed, for example, in response to the user adding the corresponding media asset 602 into the media queue. In some embodiments, information portion 606 may be placed below media listing 604 in an overlay window and be removed after a predetermined amount of time has elapsed. In some embodiments, information portion 606 may be provided in a region that overlays a portion of an information region for media listing 514.

Control circuitry 304 may determine whether to display the navigation indicator associated with media asset 514 that is being played back in video region 512. As described above, control circuitry 304 may retrieve the media identifiers associated with media asset 514—the “Featured” media identifier, the “Aol Autos” media identifier, and the “TRANSLOGIC” media identifier. Control circuitry 304 may compare This with the media identifiers associated with the current location of highlight region 506—e.g., the “All Channels” media identifier, the “Associated Press” media identifier, and the “U.S.” media identifier. Upon performing the comparison, control circuitry 304 may generate a distance metric that shows the two sets of media identifiers are far apart. As the user is in a different section, the navigation indicator and its navigation cues may not correspond with any of the media identifiers displayed in media display 600. Accordingly, control circuitry 304 may determine to not display the navigation indicator associated with media asset 514 as it is being played back.

It should be noted that, in some embodiments, although the navigation indicator is not displayed, a header region 606 may continue to be displayed, where header region 606 includes a directory of the user-navigated locations within the hierarchy of the interactive media guidance application.

However, upon determining that the user has navigated to a portion of the interactive media guidance application with a media identifier associated with navigation indicator (e.g., back to the first list 502 that included the “Featured” media listing), control circuitry 304 may provide the user with the navigation indicator.

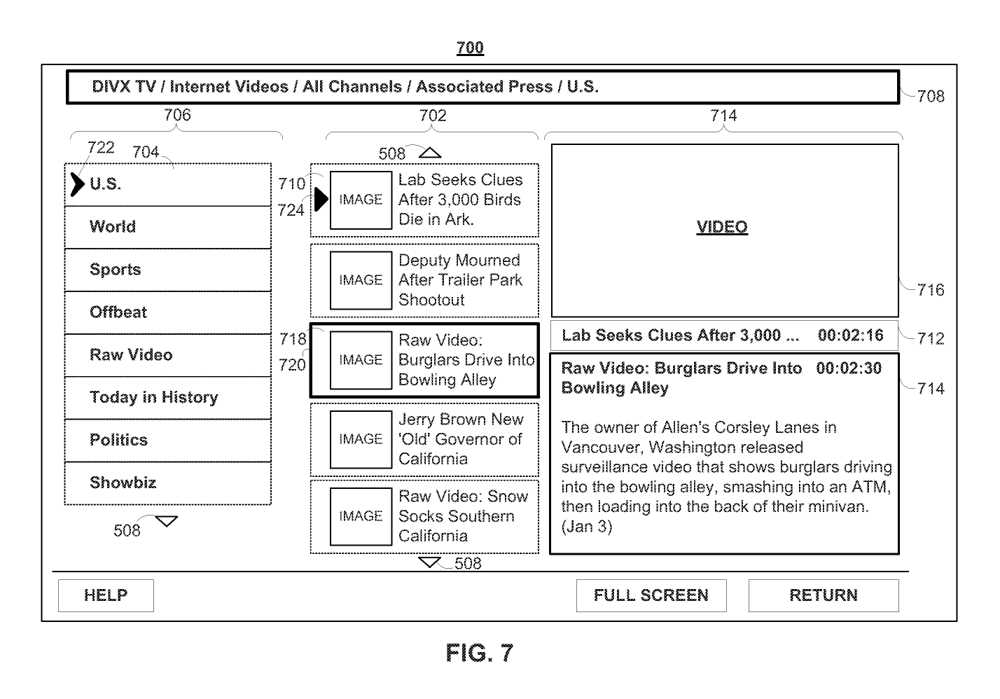

For example, as shown in a guidance display 700 of FIG. 7, the user has navigated to a list of media assets 702 upon selecting the media identifier 704 (e.g., the “U.S.” media identifier) in a list of media identifiers 706. As identified by header region 708, the user has navigated along a path that includes the media identifiers “All Channels,” “Associated Press,” and “U.S.” More particularly, in this example, the user has navigated to and selected a media asset 710 entitled “Lab Seeks Clues After 3,000 Birds Die in Arkansas” for playback. In response, control circuitry 304 may add a corresponding media listing 712 into a media queue 714 for playback in video region 716. In addition, guidance display 700 shows that the user has navigated to another media asset 716 using a highlight region 720 (e.g., a media asset 718 entitled “Raw Video: Burglars Drive into Bowling Alley”).

It should be noted that, in some embodiments, the list, of media assets 702 shown in guidance display 700 may remain in guidance display 700 while the user navigates through the hierarchy of media identifiers. For example, control circuitry 304 may allow the user to access different levels of the hierarchy with different lists of media identifiers within list 706. In a more particular example, in response to receiving an indication that the user has selected navigation cue 722, control circuitry 304 may access and display a preceding list of media identifiers in the region where list 706 is currently displayed.

In some embodiments, control circuitry 304 may receive an indication that media asset 712 is being played back in video region 716 of media queue 714. In response to receiving the indication, control circuitry 304 may retrieve the navigation indicator associated with media asset 712 and determine whether the navigation indicator may be displayed in list of media identifiers 706, list of media assets 702, and/or any other suitable portion of guidance display 700. For example, control circuitry 304 may determine the location of highlight region 720 (which is currently on media asset 718). Control circuitry 304 may compare the location of media asset 710 within list of media assets 702 with the location of highlight region 720. In response to determining that the user has navigated away from media asset 710, control circuitry 304 may display the navigation indicator and its associated navigation cues 722 and 724.

Alternatively, control circuitry 304 may determine which media identifier is associated with media asset 710. For example, control circuitry 304 may determine the media identifier that, upon selection, provided the user with list of media assets 702, which contains media asset 710. Control circuitry 304 may also retrieve information relating to the currently selected media identifier. In response to determining that the currently selected media identifier matches the media identifier associated with list of media assets 702 (e.g., the user is navigating through the same list of media assets), control circuitry 304 may determine to not display the navigation indicator.

In addition, control circuitry 304 may determine whether to display the navigation indicator in guidance display 700 based on the location of the currently selected media identifier. For example, as described above, control circuitry 304 may retrieve the media identifiers associated with media asset 710 that is currently being played back and compare them with the currently displayed media identifiers. Upon performing the comparison, control circuitry 304 may determine that the currently displayed media identifiers match at least some of the media identifiers associated with media asset 710. In response, control circuitry 304 may display the navigation indicator and its navigation cues 722 and 724 as shown in FIG. 7.

In some embodiments, control circuitry 304 may provide the user with any suitable navigation cues. For example, navigation cue 722 and other navigation cues may include a directional component. As shown in FIG. 7, control circuitry 304 may display navigation cue 722 as a directional arrow that points the user in the direction through the navigation hierarchy to navigate back to list of media assets 702 that includes media asset 710 that is currently being played back in video region 716. In a more particular example, upon directing the user to move one level deeper in the navigation hierarchy, control circuitry 304 may continue to display navigation cues until the user is directed to list of media assets 702 that includes media asset 710.

In some embodiments, navigation cues 522 and 524 of the navigation indicator may be any suitable shape (e.g., arrows, circular, rectangular, etc.), any suitable color (e.g., blue, yellow, etc.), any suitable order of shapes (e.g., arrows for the first and second lists of media identifiers 502 and 504 and rectangles for the media identifier that leads to the list of media assets), any suitable order of colors, etc. For example, as shown in FIG. 7, control circuitry 304 provides navigation cue 722 to direct the user to list of media assets 702 and provides navigation cue 724 (e.g., in the form of a triangular play indicator) to indicate that media asset 710 is being played back. Control circuitry 304 may also assign a particular shape to navigation cue 724 to indicate that the path through the hierarchy terminates at media asset 710. In another example, control circuitry 304 may assign navigation cues 722 and 724 a color within a range of colors based on the distance or a distance metric from the associated media asset. In a more particular example, navigation cues 722 and 724 along with other navigation cues may be assigned a bright shade of red when the navigation cue is close to the end of the path or the location of the associated media asset.

In some embodiments, in addition to providing navigation cues as a directional arrow, control circuitry 304 may provide a visual indicator directing the user from media identifier to media identifier through the hierarchy. For example, as shown in FIG. 8, control circuitry 304 may display navigation cue 802 in the form of multiple connected arrows, which guides the user in either direction through the hierarchy. In a more particular example, the user may be directed from navigation cue 802 to navigation 804, which identifies media asset 710 from list of media assets 702. The user may also be directed from navigation cue 802 to back option 806. Control circuitry 304 may generate back option 806 to allow the user to navigate to a preceding media identifier. For example, control circuitry 304 may transmit a query to determine the media identifiers associated with the navigation indicator. Upon retrieving the media identifiers, control circuitry 304 may populate the media identifiers into back option 806 in the form of a drop-down menu. Using back option 806, control circuitry 304 may allow the user to navigate to, for example, the “All Channels” media identifier and its corresponding list of media identifiers.

In some embodiments, control circuitry 304 may provide multiple navigation indicators within a guidance display. For example, control circuitry 304 may provide multiple navigation indicators, each with a particular shape and/or color, to allow the user to determine which media assets in a list of media assets have been selected, which media identifiers in one or more lists of media identifiers have been selected, etc.

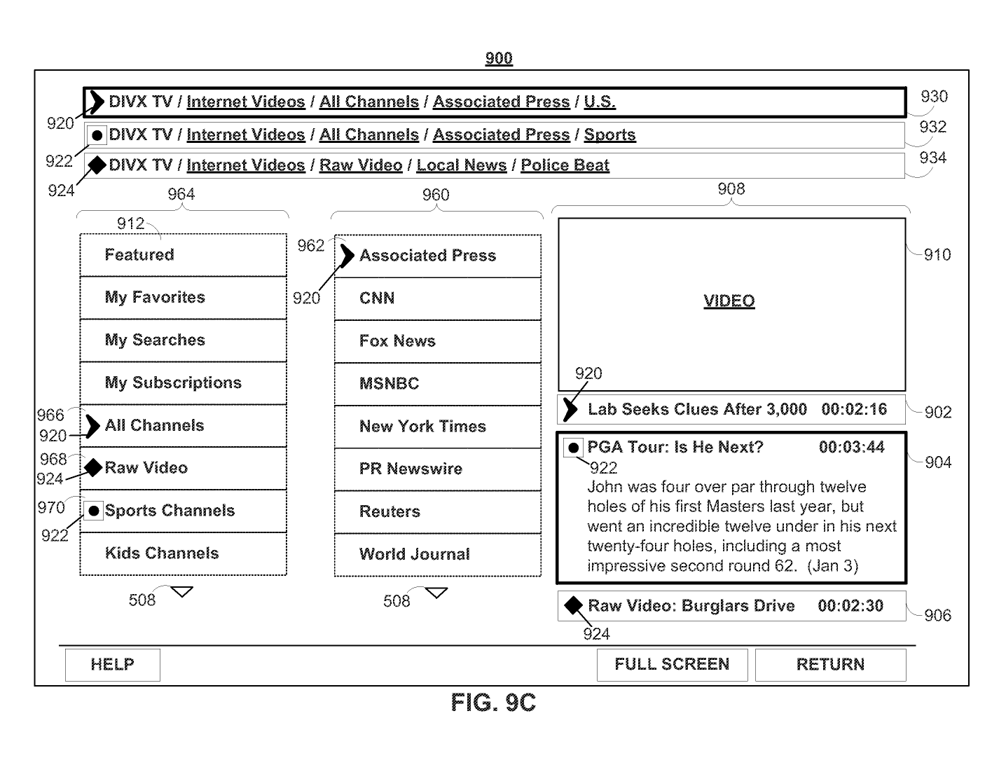

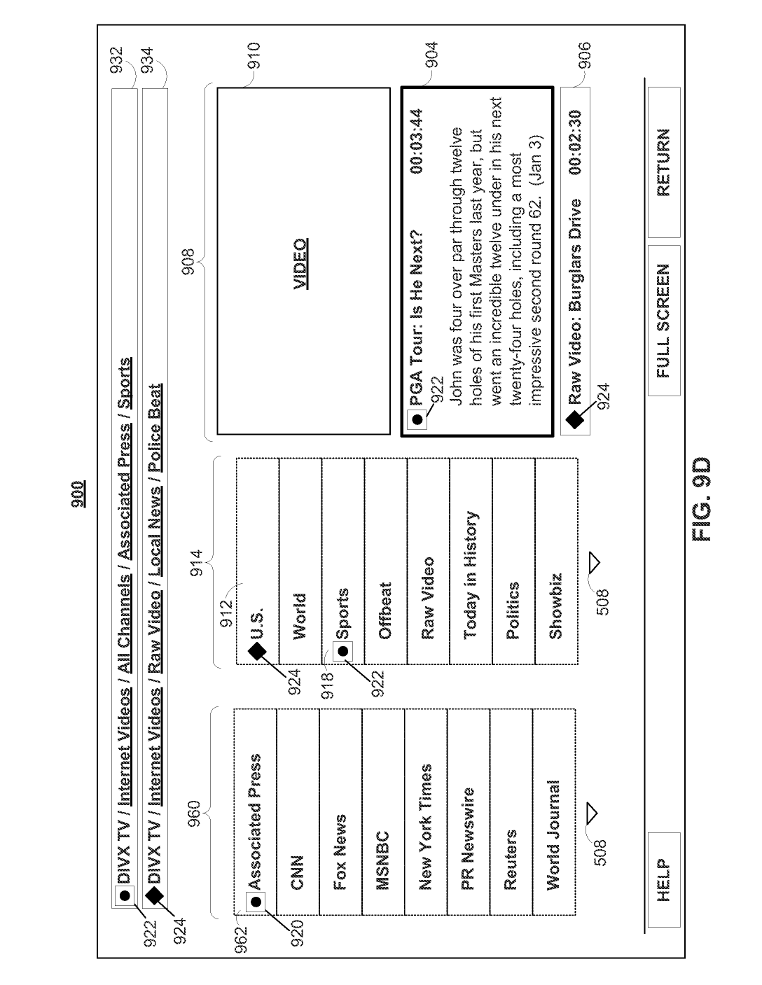

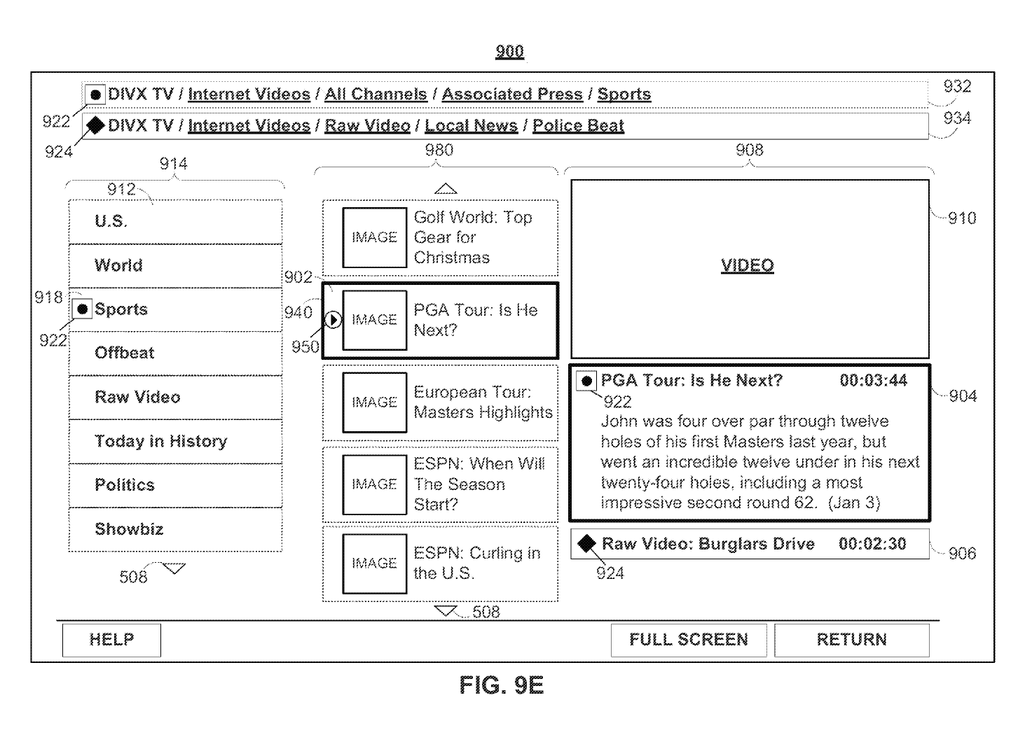

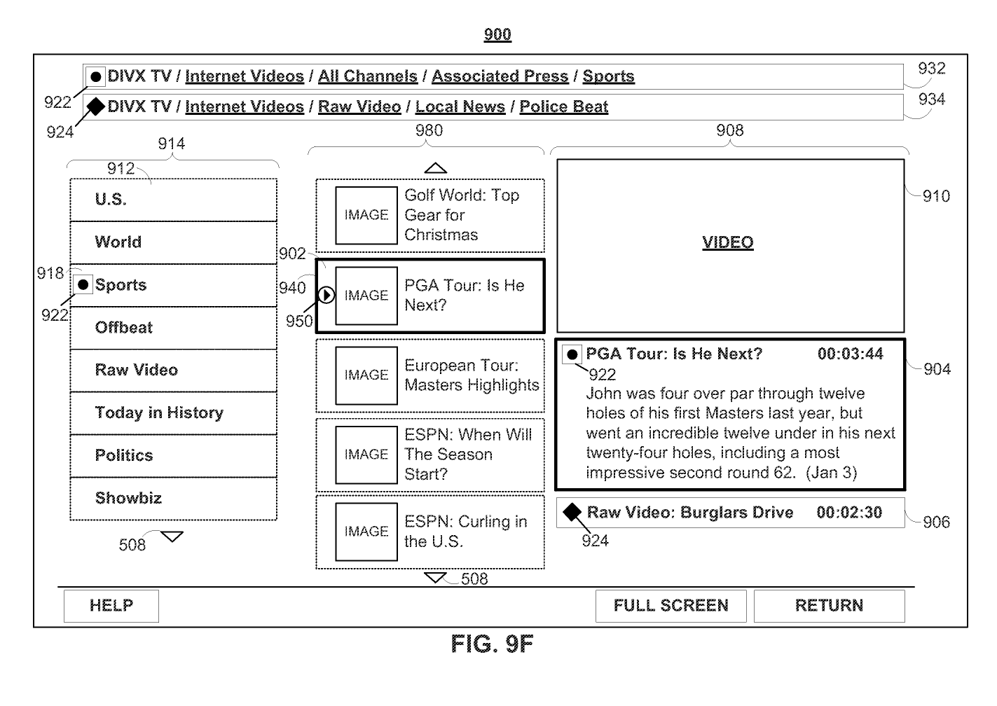

Examples of an illustrative guidance display that includes multiple navigation indicators are shown in FIGS. 9A-9F. As shown in FIG. 9A, the user has selected at least three media assets 902, 904, and 906, which have been placed by control circuitry 304 into media queue 908. As also shown, media asset 902 entitled “Lab Seeks Clues After 3,000 Birds Die in Arkansas” is currently being played back to the user in video region 910.

In some embodiments, control circuitry 304 may assign each selected media asset with a navigation cue that has a particular shape and/or color. For example, as shown in FIGS. 9A-9F, control circuitry 304 has assigned the navigation indicator associated with media asset 902 with navigation cue 920 in the shape of an arrowhead. Similarly, control circuitry 304 has assigned the navigation indicator associated with media asset 904 with navigation cue 922 in the shape of a blackened circle within the bounds of a square and control circuitry has assigned the navigation indicator associated with media asset 906 with navigation cue 924 in the shape of a diamond. Navigation cues 920, 922, and 924 may be placed in any suitable location within guidance display 900. For example, as shown in FIG. 9A, control circuitry 304 has placed navigation cue 920 on a media identifier 912 within a list of media identifiers 914, on media asset 902 in media queue 908, on the media asset 902 in a list of media assets 916, and/or on a directory 930 within a header portion of media guidance display 900. In another example, control circuitry 304 has placed navigation cue 922 on a media identifier 918 within list of media identifiers 914, on the media asset 904 in media queue 908, and/or on a directory 932 within a header portion of media guidance display 900.

As described above, control circuitry 304 may determine whether each navigation indicator and/or navigation cue should be displayed. For example, as shown in FIG. 9A, control circuitry 304 may determine the current location of highlight region 940. In response to determining that the user at the current location has navigated away from the locations associated with navigation indicators for media asset 902, 904, and 906, control circuitry 304 may provide the navigation indicators and their navigation cues (e.g., navigation cues 920, 922, and/or 924).

It should be noted that control circuitry 304 may dynamically update navigation cues 920, 922, and 924.

In some embodiments, control circuitry 304 may dynamically update navigation cues 920, 922, and 924 as the user navigates through the interactive media guidance application. For example, the user may navigate back through the hierarchy to preceding lists of media identifiers. In a more particular example, the user may select navigation cue 920 in list of media identifiers 914 in FIG. 9A. In response, control circuitry 304 may shift list of media identifiers 914 into the position of list of media assets 916 and display another list of media identifiers 960 as shown in FIG. 9B. Alternatively, the user may move highlight region 940 to the left, thereby revealing column or list of media identifiers 960 to the left of list of media identifiers 914. As also shown in FIG. 9B, upon revealing another level of the navigation hierarchy, control circuitry 304 may update the placement of navigation cues 920, 922, and 924. Navigation cue 920 remains placed on media identifier 912 within list of media identifiers 914, on media asset 902 in media queue 908, and on directory 930 within a header portion of media guidance display 900. In addition, control circuitry 304 may also place navigation cue 920 on an “Associated. Press” media identifier 962 in list of media identifiers 960.

In another example, FIG. 9C shows that the user has continued to navigate back through the hierarchy so preceding lists of media identifiers while media asset 902 is being played back in video region 910. For example, the user may select navigation cue 920 in list of media identifiers 960 in FIG. 9B to continue being guided back through the hierarchy. In response, control circuitry 304 may shift list of media identifiers 960 into the position of list of media identifiers 914 and display another list of media identifiers 964 as shown in FIG. 9C. Alternatively, the user may move highlight region 940 to the left, thereby revealing column or list of media identifiers 964 to the left of list of media identifiers 960. As also shown in FIG. 9C, upon revealing another level of the navigation hierarchy, control circuitry 304 may update the placement of navigation cues 920, 922, and 924. Navigation cue 920 remains placed on media asset 902 in media queue 903, on directory 930 within a header portion of media guidance display 900, and on media identifier 962 (“Associated Press”) within list of media identifiers 960. In addition, control circuitry 304 may place navigation cue 920 on an “All Channels” media identifier 966 in list of media identifiers 960. As list of media identifiers 964 reveals a “Raw Video” media identifier 968 associated with media asset 906, control circuitry 304 may also update navigation cue 924 to be placed on media identifier 968 within list of media identifier 964.

Referring to FIGS. 9A and 9C, in some embodiments, control circuitry 304 may display navigation indicators and/or navigation cues that identify another instance or copy of the same media asset. For example, as shown in directory 934 of FIG. 9A, media asset 906 is provided in a list of media assets corresponding to the “Police Beat” media identifier. In addition, media asset 906 also appears in list of media assets 916 corresponding to the “U.S.” media identifier. In response so detecting another instance or copy of the same media asset 906, control circuitry 304 may provide the navigation cue 924 on the second instance of the media asset.

Similarly, in the example shown in FIG. 9C, guidance display 900 includes directory 932 indicating that the media identifiers associated with media asset 904 are the “All Channels” media identifier, the “Associated Press” media identifier, and the “Sports” media identifier. As shown in FIG. 9C, although the list of media identifiers that includes the “Sports” media identifier is not currently displayed, control circuitry 304 has detected that media asset 904 is also present in a list of media assets associated with a “Sports Channels” media identifier 970. In response, control circuitry 304 may place navigation cue 924 on media identifier 970 in list of media identifiers 964.

In some embodiments, control circuitry 304 may dynamically update navigation cues 920, 922, and 924 as media assets are being played back to the user. For example, when media asset 902 has been played back and media asset 904 entitled “PGA Tour: Is He Next?” is about to be played back in video region 910, control circuitry 304 may update the navigation cues displayed in guidance display 900. As shown in FIG. 9B, control circuitry 304 has placed navigation cue 920 on media identifier 962 within list of media identifiers 960 and on media identifier 912 within list of media identifiers 914. In FIG. 9D, media asset 902 has been played back and media asset 904 has moved to the top of media queue 908. As media asset 904 begins to play in video region 910, control circuitry 304 may replace navigation indicator 920 that was placed adjacent no media identifier 962 (“Associated Press”) with navigation indicator 922 as media asset 904 is also associated with media identifier 962. Similarly, as described in the example above, control circuitry 304 has detected that another instance or copy of media asset 906 appears in list of media assets 916 corresponding to the “U.S.” media identifier 912. As media asset 904 begins to play in video region 910, control circuitry 304 may also replace navigation indicator 920 that was placed adjacent to media identifier 912 (“U.S.”) with navigation indicator 924.

In some embodiments, control circuitry 304 may allow the user to select one of the directories 930, 932, and 934 in the header region of guidance display 900. In some embodiments, in response to selecting one of the directories, control circuitry 304 may navigate through the hierarchy such that the user is returned to the location within the interactive media guidance application that includes the list of media assets including the media asset corresponding to the directory. For example, as shown in FIG. 9D, the user may select directory 932 in guidance display 900. In response to receiving a user selection of directory 932, control circuitry 304 may navigate the user through the hierarchy and present the user with the guidance display shown in FIG. 9F. As shown, control circuitry 304 has navigated the user to a terminal node or branch that provides a list of media assets 980 that includes media asset 904 associated with selected directory 932. In this example, control circuitry 304 may present the user with list of media assets 980 that includes media asset 904 as well as list of media identifiers 914 that includes the preceding “Sports” media identifier 913 that, upon selection, provides the user with list of media assets 980. In addition, control circuitry 304 may also place highlight region 940 on media asset 904 in list of media assets 980.

Alternatively, in response to selecting one of the directories, control circuitry 304 may highlight the path for navigating through the hierarchy to the corresponding media asset. For example, as shown in FIG. 9F, control circuitry 304 may highlight the media identifier for selection with list of media identifiers 914, the media asset within list of media assets 916, and the media asset in media queue 908.

Referring to FIGS. 9A and 9F, in some embodiments, control circuitry 304 may assign a particular navigation cue to a media asset as it is being played back. For example, as shown in FIG. 9A, control circuitry 304 displays a navigation cue 950 in the form of a play button to indicate that media asset 902 is currently being played back in video region 910. Control circuitry 304 may update navigation cue 950 to move from media asset to media asset (e.g., media asset 902 in FIG. 9A to media asset 904 in FIG. 9F) in response to playback in media queue 908. Alternatively, control circuitry 304 may display a particular navigation cue to indicate that a media asset has already been played back.

In some embodiments, control circuitry 304 may play back one or more media assets in a full screen display. For example, in response to receiving an indication from the user (e.g., selecting full screen option 520 of FIG. 5, selecting video window 910 of FIGS. 9A-9F, etc.), control circuitry 304 may provide a full screen video window 1010 playing back media asset 1020 in the media queue, followed by media asset 1030. Control circuitry 304 may allow the user to control the playback of the media assets using controls 1040.

In addition, control circuitry 304 may display a media identifier 1050 associated with media asset 1020, which is currently being played back. Media identifier 1050 may dynamically change to correspond with the media asset that is currently being played back. In some embodiments, control circuitry 304 may allow the user to select media identifier 1050. In response to receiving the user selection, control circuitry 304 may display an overlay window that includes the list of media assets corresponding to media identifier 1050. The user may navigate back to a list of media assets for selecting and placing additional media assets into the media queue.

As described above, there may be scenarios in which navigation indicators and/or navigation cues may be provided to assist the user to navigate back to a media asset that is currently being played back. For example, the user may have a desire to view or listen to a media asset from the same content source that is currently providing the media asset. In another example, the user may have a desire to view or listen to related media assets associated with the media identifier of the media asset that is currently being played back. In yet another example, the user may have a desire to traverse the same path that led the user to the media asset. In this particular example, the user may have recalled another media asset that interested the user, but was not selected by the user as the user traversed that path.

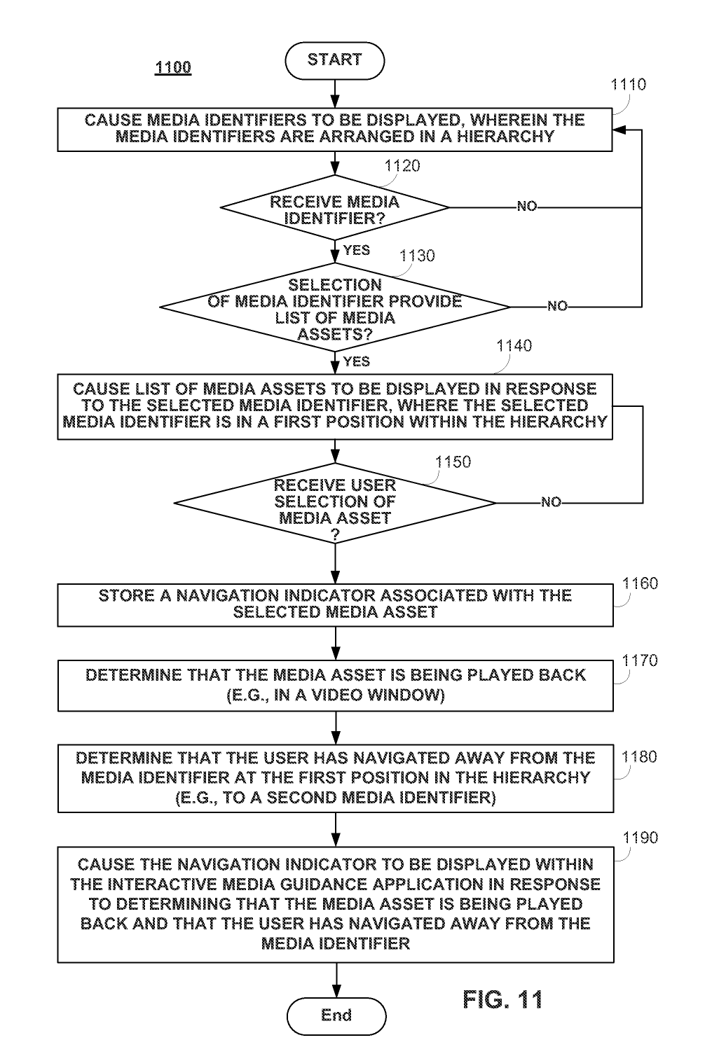

FIG. 11 illustrates a flow diagram 1100 for presenting an interactive media guidance application that includes navigation indicators in accordance with some embodiments of the invention.

At step 1110, control circuitry 304 may present the user with a list of media identifiers. Media identifiers may be arranged in a hierarchy of the interactive media guidance application. For example, the control circuitry 304 may transmit a query to media content source 416, media guidance data source 416, a metadata source, or any other suitable source to retrieve navigation hierarchy information to generate one or more guidance displays. In a more particular example, FIG. 5 provides a first list of media identifiers 502 and a second list of media identifiers 504, where second list of media identifiers 504 are displayed in response to selecting a media identifier from first list of media identifiers 502.

In response, control circuitry 304 may receive an indication from the user of a media identifier from the displayed media identifiers at step 1120. For example, as shown in FIG. 5, control circuitry 304 may receive an indication that the user has selected the “Featured” media identifier 522. In another example, as also shown in FIG. 5, control circuitry 304 may receive an indication that the user has selected the “Aol Autos” media identifier 524.

In response to receiving the selected media identifier at step 1120, control circuitry 304 may determine whether the selected media identifier provides a list of media assets for presentation to the user. For example, control circuitry 304 may transmit a query that includes the selected media identifier and, in response, may receive an additional list of media identifiers or a list of media assets. More particularly, as the user continues to navigate through the hierarchy, control circuitry 304 provides the user with lists of media identifiers until providing a terminal node or branch that is generally a list of media assets for user selection. For example, as described above, in response to receiving an indication that the user has selected the “Featured” media identifier 524 in FIG. 5, control circuitry 304 may retrieve and display a second list of media identifiers 504 that includes the media identifiers “Aol Autos” and “Revision3.” In response to receiving an indication that the user has selected the “Aol Autos” media identifier, control circuitry 304 may provide a list of media assets.

At step 1140, control circuitry 304 may cause a list of media assets to be display in response to the selected media identifier. It should be noted that the selected media identifier is in a first position with the hierarchy of the interactive media guidance application. An illustrative list of media assets is shown, for example, in guidance display 600 of FIG. 6. Control circuitry 304 may allow the user to scroll through different media assets and/or access information on each of the media assets.

At step 1150, control circuitry 304 may receive a user selection of a media asset from the list of media assets. In response to receiving the user selection, control circuitry 304 may store a navigation indicator associated with the selected media asset at step 1160. The navigation indicator may represent a path for navigating through the hierarchy of the interactive media guidance application to the selected media asset. For example, control circuitry 304 may store each media indicator along the path to navigate to the selected media asset. In another example, control circuitry 304 may only store the media indicator that provided the list of media assets that includes the selected media asset. In yet another example, control circuitry 304 may store location information within the hierarchy associated with the selected media asset.

In some embodiments, in addition to storing the navigation indicator, control circuitry 304 may transmit a query to a database for the selected media asset. In response to receiving the selected media asset, control circuitry 304 may place the selected media asset in a media queue for playback.

At step 1170, control circuitry 304 may determine that the media asset is being played back. For example, control circuitry 304 may receive an indication that the media asset is being played back in a video region. In response to determining that the media asset is being played back (or about to be played back), control circuitry 304 may determine whether the user has navigated away from the selected media identifier at step 1180. Control circuitry 304 may retrieve the stored navigation indicator to perform this determination. For example, control circuitry 304 may retrieve, from the navigation indicator, location information of the selected media identifier that provided the list of media assets that includes the selected media asset. Control circuitry 304 may also retrieve the current location of a highlight region or a cursor and compare it with the location information from the navigation indicator. In another example, control circuitry 304 may retrieve, from the navigation indicator, the location of the media asset within the hierarchy and may compare the current location of a highlight region or cursor with that location.

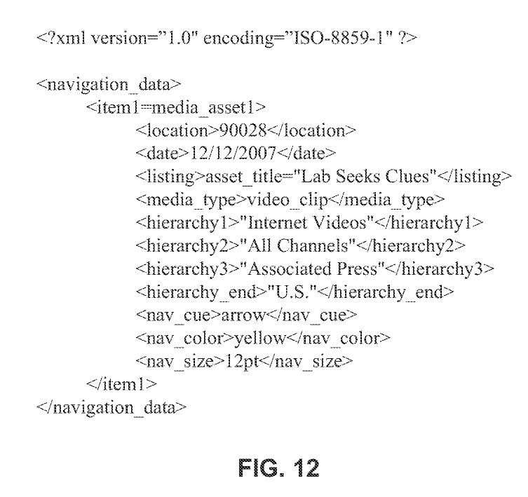

Any suitable mechanism for storing and/or retrieving navigation indicators associated with media assets may be used. For example, in some embodiments, control circuitry 304 may transmit a query to storage for the navigation indicator associated with the selected media asset. In response to receiving the navigation indicator from storage (e.g., in an XML structure as illustrated in FIG. 12), control circuitry 304 may determine location information, media identifier information, or other suitable information for determining whether the user has navigated away from the selected media asset or its associated media identifiers. Upon determining that the user has selected another media asset for placement in the media queue, control circuitry 304 may save another navigation indicator in storage (e.g., in an XML structure as illustrated in FIG. 12).

In response to determining that the user has navigated away from the media identifier and, for example, to another media identifier or another portion of guidance display 500, control circuitry 304 may cause the navigation indicator associated with the media asset being played back to be displayed to the user at step 1190.

It should be noted that, in some embodiments, control circuitry 304 may determine whether navigation indicator and its associated navigation cues may be presented to the user. For example, control circuitry 304 may retrieve the media identifiers associated with the selected media asset by reviewing the associated navigation indicator (e.g., in an XML structure as illustrated in FIG. 12) and compare this with the media identifiers associated with the current location of the highlight region or cursor. For example, if the user is in a section remote from the media identifier that led the user to the selected media asset, the navigation indicator and its navigation cues may not correspond with any of the display media identifiers. Based on this determination, control circuitry 304 may determine no not display the navigation indicator associated with the selected media asset as it is being played back.

In some embodiments, control circuitry 304 may display a navigation indicator that includes one or more navigation cues. For example, the first navigation indicator may include a first navigation cue that identifies which media identifier to select from a first portion of the media identifiers and a second navigation cue that identifies which media identifier to select from a second portion of media identifiers after selecting the media identifier from the first portion in order to navigate back to the first media asset. The first and second navigation cues may be placed adjacent to the particular media identifier. The first and second navigation cues may also be any suitable shape, color, size, ordering of shapes (e.g., the first navigation cue is circular and the second navigation cue is rectangular), and/or ordering of colors (e.g., the first navigation cue is blue and the second navigation cue is yellow).

In some embodiments, in addition to the navigation indicator, control circuitry 304 may display a header region in the guidance display that includes a directory of the user-navigated locations within the hierarchy of the interactive media guidance application. For example, control circuitry 304 may transmit a query that requests the media identifiers selected to obtain a list of media assets that includes the selected media asset. Upon receiving the response to the query, control circuitry 304 may compile the retrieved media identifier information into a directory within a header region in the guidance display.

It should be understood that the above steps of the flow diagram of FIG. 11 may be executed or performed in any order or sequence not limited to the order and sequence shown and described in the figure. Also, some of the above steps of the flow diagram of FIG. 11 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

What is claimed is:

1. A method for navigating an interactive media guidance application, the method comprising:
storing a plurality of media identifiers, wherein each of the plurality of media identifiers is arranged in a hierarchy of the interactive media guidance application;
causing a plurality of media assets to be displayed in response to a user selecting a first of the plurality of media identifiers, wherein the first media identifier is in a first position within the hierarchy;
receiving a user selection of a first media asses from the plurality of media assets;
storing a first navigation indicator associated with the first media asset in response so receiving the user selection of the first media asset, wherein the first navigation indicator represents a path for navigating through the hierarchy of the interactive media guidance application to the first media asset;
determining that the first media asset is being played back after the user navigates away from the first media identifier to a second media identifier of the plurality of media identifiers, wherein the second media identifier is in a second position within the hierarchy; and
causing the first navigation indicator to be displayed within the interactive media guidance application in response to the determining that the media asset is being played back after the user navigates to the second media identifier.

2. The method of claim 1, wherein the first navigation indicator comprises a first navigation cue that identifies which media identifier to select from a first portion of the plurality of media identifiers and a second navigation cue that identifies which media identifier to select from a second portion of the plurality of media identifiers after selecting the media identifier from the first portion in order to navigate back to the first media asset.

3. The method of claim 1, further comprising:
adding the first media asset to a playlist of media assets in response to receiving the user selection of the first media asset;
causing the playlist of media assets to be displayed to the user.

4. The method of claim 1, wherein the first navigation indicator is concurrently displayed with the first media asset.

5. The method of claim 1, further comprising:
receiving a user selection of a second media asset, wherein the first navigation indicator is displayed during navigation and selection of the second media asset; and
storing a second navigation indicator associated with the second media asset in response to receiving the user selection of the second media asset, wherein the second navigation indicator represents a path for navigating through the hierarchy of the interactive media guidance application to the second media asset.

6. The method of claim 5, further comprising:
causing the first navigation indicator to be displayed while the first media asset is being played back; and
causing the second navigation indicator to be displayed instead of the first navigation indicator while the second media asset is being played back.

7. The method of claim 1, further comprising:
receiving navigation instructions from the user to navigate through the plurality of media identifiers; and
determining whether to display the first navigation indicator in response to receiving the navigation instructions based on a position within the hierarchy that has been navigated to by the navigation instructions.

8. The method of claim 1, further comprising:
storing a directory of user-navigated locations within the hierarchy of the interactive media guidance application, wherein the directory is associated with the plurality of navigation indicators; and
causing the directory of user-navigated locations to be displayed to the user in a header region.

9. The method of claim 1, further comprising:
causing a first information region associated with the first media asset to be displayed; and
causing a second information region associated with a second media asset to overlay a portion of the first information region.

10. The method of claim 1, wherein the first navigation indicator includes a cue having at least one of: a shape, a color, an ordering of shapes, and an ordering of colors.

11. A system for navigating an interactive media guidance application, the system comprising:
a storage device;
processing circuitry configured to:
store a plurality of media identifiers in the storage device, wherein each of the plurality of media identifiers is arranged in a hierarchy of the interactive media guidance application;
cause a plurality of media assets to be displayed in response to a user selecting a first of the plurality of media identifiers, wherein the first media identifier is in a first position within the hierarchy;
receive a user selection of a first media asset from the plurality of media assets;
store a first navigation indicator associated with the first media asset in the storage device in response to receiving the user selection of the first media asset, wherein the first navigation indicator represents a path for navigating through the hierarchy of the interactive media guidance application to the first media asset;
determine that the first media asset is being played back after the user navigates away from the first media identifier to a second media identifier of the plurality of media identifiers, wherein the second media identifier is in a second position within the hierarchy; and
cause the first navigation indicator to be displayed within the interactive media guidance application in response to the determining that the media asset is being played back after the user navigates to the second media identifier.

12. The system of claim 11, wherein the first navigation indicator comprises a first navigation cue that identifies which media identifier to select from a first portion of the plurality of media identifiers and a second navigation cue that identifies which media identifier to select from a second portion of the plurality of media identifiers after selecting the media identifier from the first portion in order to navigate back to the first media asset.

13. The system of claim 11, wherein the processing circuitry is further configured to:
add the first media asset to a playlist of media assets in response to receiving the user selection of the first media asset;
cause the playlist of media assets to be displayed to the user.

14. The system of claim 11, wherein the first navigation indicator is concurrently displayed with the first media asset.

15. The system of claim 11, wherein the processing circuitry is further configured to:
receive a user selection of a second media asset, wherein the first navigation indicator is displayed during navigation and selection of the second media asset; and
store a second navigation indicator associated with the second media asset in response to receiving the user selection of the second media asset, wherein the second navigation indicator represents a path for navigating through the hierarchy of the interactive media guidance application to the second media asset.

16. The system of claim 15, wherein the processing circuitry is further configured to:
cause the first navigation indicator to be displayed while the first media asset is being played back; and
cause the second navigation indicator to be displayed instead of the first navigation indicator while the second media asset is being played back.

17. The system of claim 11, wherein the processing circuitry is further configured to:
receive navigation instructions from the user to navigate through the plurality of media identifiers; and
determine whether to display the first navigation indicator in response to receiving the navigation instructions based on a position within the hierarchy that has been navigated to by the navigation instructions.

18. The system of claim 11, wherein the processing circuitry is further configured:
store a directory of user-navigated locations within the hierarchy of the interactive media guidance application, wherein the directory is associated with the plurality of navigation indicators; and
cause the directory of user-navigated locations to be displayed to the user in a header region.

19. The system of claim 11, wherein the processing circuitry is further configured to:
cause a first information region associated with the first media asset to be displayed; and
cause a second information region associated with a second media asset to overlay a portion of the first information region.

20. The system of claim 11, wherein the first navigation indicator includes a cue having at least one of: a shape, a color, an ordering of shapes, and an ordering of colors.

21. An apparatus for navigating an interactive media guidance application, the apparatus comprising:
means for storing a plurality of media identifiers, wherein each of the plurality of media identifiers is arranged in a hierarchy of the interactive media guidance application;
means for causing a plurality of media assets to be displayed in response to a user selecting a first of the plurality of media identifiers, wherein the first media identifier is in a first position within the hierarchy;
means for receiving a user selection of a first media asset from the plurality of media assets;
means for storing a first navigation indicator associated with the first media asset in response to receiving the user selection of the first media asset, wherein the first navigation indicator represents a path for navigating through the hierarchy of the interactive media guidance application to the first media asset;
means for determining that the first media asset is being played back after the user navigates away from the first media identifier to a second media identifier of the plurality of media identifiers, wherein the second media identifier is in a second position within the hierarchy; and
means for causing the first navigation indicator so be displayed within the interactive media guidance application in response to the determining that the media asset is being played back after the user navigates to the second media identifier.

22. The apparatus of claim 21, wherein the first navigation indicator comprises a first navigation cue that identifies which media identifier to select from a first portion of the plurality of media identifiers and a second navigation cue that identifies which media identifier to select from a second portion of the plurality of media identifiers after selecting the media identifier from the first portion in order to navigate back to the first media asset.

23. The apparatus of claim 21, further comprising:
means for adding the first media asset to a playlist of media assets in response to receiving the user selection of the first media asset;
means for causing the playlist of media assets to be displayed to the user.

24. The apparatus of claim 21, wherein the first navigation indicator is concurrently displayed with the first media asset.

25. The apparatus of claim 21, further comprising:
means for receiving a user selection of a second media asset, wherein the first navigation indicator is displayed during navigation and selection of the second media asset; and
means for storing a second navigation indicator associated with the second media asset in response to receiving the user selection of the second media asset, wherein the second navigation indicator represents a path for navigating through the hierarchy of the interactive media guidance application to the second media asset.

26. The apparatus of claim 25, further comprising:
means for causing the first navigation indicator to be displayed while the first media asset is being played back; and
means for causing the second navigation indicator to be displayed instead of the first navigation indicator while the second media asset is being played back.

27. The apparatus of claim 21, further comprising:
means for receiving navigation instructions from the user to navigate through the plurality of media identifiers; and
means for determining whether to display the first navigation indicator in response to receiving the navigation instructions based on a position within the hierarchy that has been navigated to by the navigation instructions.

28. The apparatus of claim 21, further comprising:
means for storing a directory of user-navigated locations within the hierarchy of the interactive media guidance application, wherein the directory is associated with the plurality of navigation indicators; and
means for causing the directory of user-navigated locations to be displayed to the user in a header region.

29. The apparatus of claim 21, further comprising:
means for causing a first information region associated with the first media asset to be displayed; and
means for causing a second information region associated with a second media asset to overlay a portion of the first information region.

30. The apparatus of claim 21, wherein the first navigation indicator includes a cue having at least one of a shape, a color, an ordering of shapes, and an ordering of colors.
